(19) United States
(12) Patent Application Publication
(10) Pub. No.: US 2022/0229153 A1
(43) Pub. Date: Jul. 21, 2022

(54) ABNORMALITY DIAGNOSIS SYSTEM

(71) Applicant: Robert Bosch GmbH, Stuttgart (DE)

(72) Inventors: Bjoern Fassbender, Kanagawa (JP); Christian Braeuchle, Kanagawa (JP)

(21) Appl. No.: 17/609,066

(22) PCT Filed: May 4, 2020
(86) PCT No.: PCT/IB2020/054182

§ 371 Date: Nov. 5, 2021

(30) Foreign Application Priority Data
May 6, 2019 (JP) 2019-087220

(51) Int. Cl. G01S 7/40; G01S 19/13; G01S 13/931; G01S 13/89

(52) U.S. Cl. CPC G01S 7/40; G01S 13/89; G01S 13/931; G01S 19/13

(57) ABSTRACT

The present invention provides an abnormality diagnosis system capable of improving reliability of a diagnosis result on a state of a detector mounted to a vehicle.

An abnormality diagnosis system (50) that diagnoses abnormality of a detector (20) detecting surrounding information on the vehicle includes: a positioning device (59); a storage device (55) that stores map data (70) containing data on an object existing on/above the ground; and a control section (51) that diagnoses presence or absence of the abnormality of the detector (20) by comparing the map data (70) with detection data obtained by the detector (20).

### BACKGROUND OF THE INVENTION

The present invention relates to an abnormality diagnosis system that diagnoses abnormality of a detector mounted to a vehicle.

In recent years, vehicles traveling on roads each include a driver-assistance system and a detector that is used to realize automated driving. Examples of such a detector are a radar sensor, an imaging sensor, and a Lidar unit. Output information of these detectors is used to observe vehicle surrounding information including obstacles such as another vehicle and a pedestrian in addition to a travelable area and a road.

### SUMMARY OF THE INVENTION

In order to guarantee safe travel of the vehicle, it is desired to be able to detect an actuation state of the detector. In the case where the detector is brought into a state where the actuation state thereof cannot be detected, a vehicle system needs to handle such a state. For example, the vehicle system needs to impair system performance or stop a system function.

Conventionally, the detector detects the state of itself on the basis of an internal signal and an observation result. For example, the detector determines whether the surrounding environment is stably detected when the vehicle surrounding environment is changed, or when the vehicle surrounding environment remains the same. For example, the detector determines that the surrounding environment cannot be detected due to dirt that covers a front surface of the detector or the like when the detected surrounding environment is not changed, or when it is indicated that the surrounding environment is “null”.

However, such a conventional determination method possibly produces an erroneous diagnosis. For example, in the conventional determination method, the detector determines that the surrounding environment cannot be detected even in the case where the surrounding environment actually remains the same or where nothing exists in the surrounding environment. Such an erroneous diagnosis is possibly made while the vehicle travels on a bridge over a wide river or a large lake or a bridge including low guardrails.

The present invention has been made in view of the above problem and therefore provides an abnormality diagnosis system capable of improving reliability of a diagnosis result on a state of a detector mounted to a vehicle.

According to an aspect of the present invention, an abnormality diagnosis system that diagnoses abnormality of a detector detecting surrounding information on a vehicle is provided. The abnormality diagnosis system includes: a positioning device; a storage device that stores map data containing data on an object existing on/above ground; and a control section that diagnoses presence or absence of the abnormality of the detector by comparing the map data and detection data obtained by the detector.

As it has been described so far, according to the present invention, it is possible to improve reliability of a diagnosis result on a state of the detector mounted to the vehicle.

### BRIEF DESCRIPTION OF THE DRAWINGS

FIG. 1 is a schematic view of a configuration example of an abnormality diagnosis system according to an embodiment of the present invention.

FIG. 2 is a flowchart of an example of processing executed by the abnormality diagnosis system according to the embodiment.

FIG. 3 is a flowchart of an example of processing for identifying an object detected by a radar sensor.

FIG. 4 is a flowchart of an example of abnormality determination processing executed by the abnormality diagnosis system according to the embodiment.

FIG. 5 is a schematic view of an example of a field of view from a vehicle.

FIG. 6 is a schematic view of an example of map data.

### DETAILED DESCRIPTION

A detailed description will hereinafter be made on a preferred embodiment of the present invention with reference to the accompanying drawings. In the present specification and the drawings, components having the substantially same functional configuration will be denoted by the same reference sign, and thus a description thereon will not be repeated.

### <1. Configuration Example of Abnormality Diagnosis System>

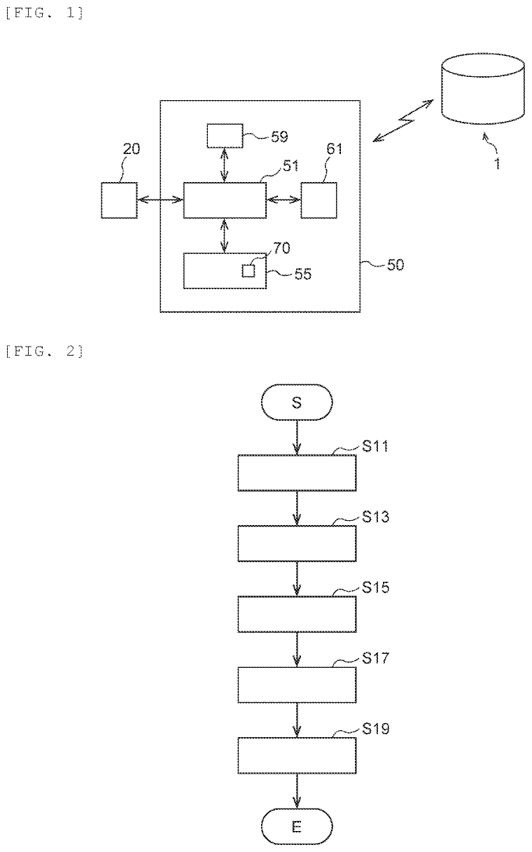

A description will be made on a configuration example of an abnormality diagnosis system 50 according to this embodiment with reference to FIG. 1. In the following embodiment, a description will be made on a radar sensor 20 as an example of a detector that detects vehicle surrounding environment. A vehicle is not particularly limited to an engine vehicle including an internal combustion engine as a drive source, an electrically-driven vehicle including an electric motor as the drive source, a hybrid vehicle including the internal combustion engine and the electric motor as the drive sources, and the like.

FIG. 1 is a schematic view of an system configuration of the vehicle that includes the abnormality diagnosis system 50. The abnormality diagnosis system 50 includes a control section 51, a storage device 55, a Global Positioning System (GPS) receiver 59, a network communication module 61, and the radar sensor 20.

The control section 51 is partially or entirely constructed of a microcontroller, an application specific integrated circuit (ASIC), a field-programmable gate array (FPGA), a microprocessor, another suitable electronic device, or the like. The control section 51 may partially or entirely be constructed of a member in which firmware or the like can be updated, or may partially or entirely be a program module or the like that is executed by a command from a central processing unit (CPU) or the like.

The control section 51 may be configured to execute a command that corresponds to one or plural types of software programs. FIG. 1 illustrates an example of the abnormality diagnosis system 50 using the single control section 51. However, as the control section 51, the plural control sections may be configured in a mutually communicable manner. Some or all functions provided by the storage device 55, the GPS receiver 59, or the network communication module 61 may be integrated with functions of the control section 51 by using hardware or software.

The control section 51 can obtain information on a travel state of the vehicle including a vehicle speed as well as a steering angle or a turning angle. These types of the information may directly be input from a vehicle speed sensor, a steering angle sensor, and the like, or may be input from another control section mounted to the vehicle via a communication bus such as a controller area network (CAN).

The GPS receiver 59 receives a GPS signal in order to determine a current position of itself on the earth. The GPS receiver 59 is an aspect of a positioning device. The network communication module 61 is connected to the control section 51 and allows the control section 51 to exchange data by using one or plural wired or wireless digital networks. The storage device 55 includes a storage element such as random access memory (RAM) or read only memory (ROM). In addition, the storage device 55 may include a storage device such as a hard disk drive (HDD) or a storage.

The storage device 55 stores map data 70. The map data 70 contains not only data on roads but also data on actual positions of lanes of the roads and objects that exist on the roads or adjacent to the roads on/above the ground. The map data 70 is map data used for automated driving control, for example. An automated driving controller, which is not illustrated, refers to the map data 70 to set a travel position at which the vehicle can safely travel.

The objects existing on/above the ground include unmoving objects that exist near the road, and examples of such objects are a traffic light, a traffic sign, a guardrail, another road crossing the road, an elevated bridge, a pole of a fence, a barrier, a land bridge, a curbstone, a parked vehicle, and a manhole cover. In this embodiment in which an abnormality diagnosis on the radar sensor 20 is made, the data on the objects existing on/above the ground contains three-dimensional data. The three-dimensional data is data that represents a partial or entire outer shape of each of the objects existing on/above the ground.

The map data 70 can be updated by using data that is provided from a map data generator on the outside of the vehicle. For example, a map data generator 1 obtains surrounding environment data transmitted from the plural vehicles, updates the three-dimensional data on the objects that exist on/above the ground at positions on the map data, and provides such data to the vehicle that can use the system. In this case, the surrounding environment data transmitted from each of the vehicles may be data on objects that are obtained by the detector in each of the vehicles, such as the radar sensor 20, detecting the surrounding environment. The map data 70 may be updated periodically or non-periodically.

The radar sensor 20 is a detector that has an emitting section emitting a radar wave and a receiving section receiving a reflected wave of the radar wave, and detects the object on the basis of the radar wave and the reflected wave. For example, the radar sensor 20 may be a detector capable of emitting the appropriate radar wave such as an intermediate-distance radar sensor or a millimeter-wave radar sensor.

The control section 51 has a function as a control section that diagnoses presence or absence of abnormality of the radar sensor 20. The control section 51 diagnoses the presence or the absence of the abnormality of the radar sensor 20 by comparing the map data 70 and detection data on the object obtained by the radar sensor 20. More specifically, the control section 51 determines whether the radar sensor 20 has detected the object on the basis of the three-dimensional data contained in the map data 70, and thereby diagnoses the presence or the absence of the abnormality of the radar sensor 20.

For example, the control section 51 may diagnose the presence or the absence of the abnormality of the radar sensor 20 on the basis of an error between the three-dimensional data on the object that exists around the position of the vehicle and is contained in the map data 70 and plural detection points detected by the radar sensor 20.

More specifically, the control section 51 identifies a GPS position that is identified by the GPS receiver 59, and determines the current position of the vehicle on the map data 70. At this time, the control section 51 may set a specified error to determine the position of the vehicle on the map data 70. After determining the position of the vehicle on the map data 70, the control section 51 identifies the object that exists within a range, which is set in advance, around the position of the vehicle.

In addition, the control section 51 processes the detection data on the object that is detected by the radar sensor 20, and thereby calculates an absolute speed of the object. For example, after calculating a relative speed between the object, which is detected by the radar sensor 20, and the vehicle, the control section 51 subtracts the vehicle speed from the relative speed by using the information on the vehicle speed and the information on the steering angle or the turning angle. In this way, the control section 51 calculates the absolute speed of the detected object. In the case where such an absolute speed is equal to or lower than a threshold value (for example, 0.5 km/h) that is set to zero or a lowest value as possible, the control section 51 determines that the detected object is a static object that exists on/above the ground.

The control section 51 compares each of the plural detection points of the object detected by the radar sensor 20 with the information on the three-dimensional data of the object identified on the map data 70, so as to calculate the error therebetween. In the case where the calculated error is equal to or larger than a specified value, the control section 51 may determine that the radar sensor 20 is abnormal. In the case where the control section 51 determines that the error is equal to or larger than the specified value not only in the single determination result but for plural times set in advance, the control section 51 may determine that the radar sensor 20 is abnormal.

### <2. Operation Example of Abnormality Diagnosis System>

A description will hereinafter be made on an operation example of the abnormality diagnosis system 50 according to this embodiment.

### (3.1. Flowchart)

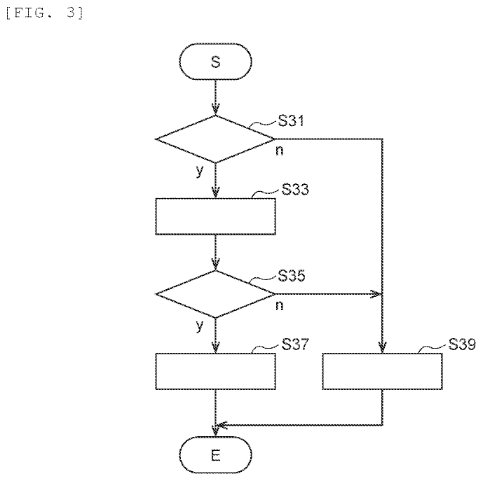

FIG. 2 is a flowchart of an example of processing executed by the abnormality diagnosis system 50. The processing executed by the abnormality diagnosis system 50 is executed in cooperation between the control section 51 and various programs stored in the storage device 55.

First, the control section 51 in the abnormality diagnosis system 50 stores the map data 70 in the storage device 55 by using the data that is transmitted from the map data generator 1 on the outside of the vehicle (step S11). In the case where the map data 70 has already been stored in the storage device 55, the map data 70 is updated by using the data transmitted from the map data generator 1.

Next, the control section 51 identifies the position of the vehicle on the map data 70 (step S13). More specifically, the control section 51 identifies the GPS position of the vehicle on the basis of the GPS signal received by the GPS receiver 59, and determines the position of the vehicle on the map data 70. As described above, the control section 51 may determine the position of the vehicle on the map data 70 by setting the specified error.

Next, the control section 51 identifies, on the map data 70, a candidate for the object that exists around the determined position of the vehicle (step S15). For example, the control section 51 may identify the candidate for the object to be detected by the detector according to a type of the detector as a diagnosis target, a detection direction from the vehicle, or the like.

Next, the control section 51 identifies the object detected by the radar sensor 20 on the basis of the detection signal obtained from the radar sensor 20 (step S17). For example, the control section 51 may identify the object detected by the radar sensor 20 according to an example illustrated in FIG. 3. The identification of the object described herein includes such identification that the object is not detected by the radar sensor 20.

First, the control section 51 determines whether any type of the object is detected by the radar sensor 20 (step S31). If the object is not detected by the radar sensor 20 (S31/n), the control section 51 determines that the static object is not detected (step S39). On the other hand, if the object is detected by the radar sensor 20 (S31/y), the control section 51 determines the absolute speed of the object detected by the radar sensor 20 (step S33). For example, the control section 51 may calculate the relative speed between the object and the vehicle by dividing a change in a distance between the detected object and the vehicle by time and subtract the vehicle speed from the relative speed, so as to determine the absolute speed of the object.

Next, the control section 51 determines whether the determined absolute speed is zero or equal to or lower than the threshold value (for example, 0.5 km/h), which is set in advance (step S35). If determining that the absolute speed of the object detected by the radar sensor 20 is not zero or exceeds the threshold value, which is set in advance, (S35/n), the control section 51 determines that the static object is not detected (step S39). On the other hand, if the determined absolute speed is zero or is equal to or lower than the threshold value, which is set in advance, (S35/y), the control section 51 determines that the static object is detected (step S37).

Returning to FIG. 2, in step S17, after identifying the object detected by the radar sensor 20, the control section 51 determines the presence or the absence of the abnormality of the radar sensor 20 by comparing the detection data obtained by the radar sensor 20 with the three-dimensional data on the object contained in the map data 70 (step S19).

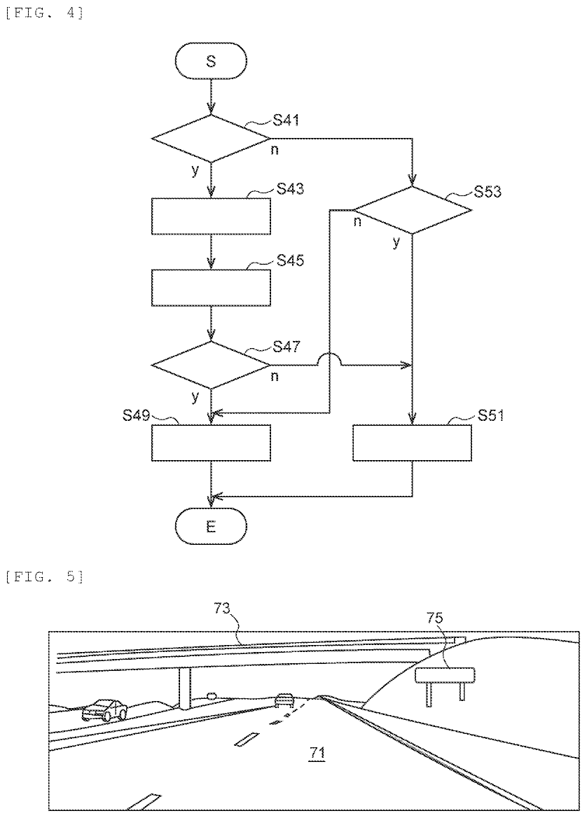

FIG. 4 illustrates an example of processing for determining the presence or the absence of the abnormality of the radar sensor 20. First, the control section 51 determines whether the static object is detected by the radar sensor 20 (step S41). If the static object is not detected (S41/n), the control section 51 determines whether the object exists in an area around the vehicle, which is identified in step S15, on the map data 70 (step S53). If the object exists around the vehicle on the map data 70 (S53/y), the control section 51 determines that the radar sensor 20 is abnormal (step S51). On the other hand, if the object does not exist around the vehicle on the map data 70 (S53/n), the control section 51 determines that the radar sensor 20 is not abnormal (step S49).

If the static object is detected by the radar sensor 20 in step S41 (S41/y), the control section 51 identifies the object on the map data 70 that corresponds to the detected object (step S43). For example, the control section 51 may identify the object on the map data 70 that corresponds to the detected object on the basis of a relative position of the object detected by the radar sensor 20 to the position of the vehicle or on the basis of the distance from the vehicle to the detected object.

Next, the control section 51 compares each of the plural detection points of the static object detected by the radar sensor 20 with the information on the three-dimensional data of the object identified on the map data 70, so as to calculate the error therebetween (step S45). For example, the control section 51 may calculate displacement of each of the detection points that are identified on the basis of the GPS position of the vehicle with respect to the three-dimensional data of the object on the map data 70, the distance from the vehicle to each of the detection points by the radar sensor 20, a direction of the vehicle with respect to each of the detection points by the radar sensor 20, and the like.

Next, the control section 51 determines whether the calculated error is equal to or smaller than a threshold value, which is set in advance, (step S47). If the calculated error is smaller than the threshold value (S47/y), the control section 51 determines that the radar sensor 20 is not abnormal (step S49). On the other hand, if the calculated error is equal to or larger than the threshold value (S47/n), the control section 51 determines that the radar sensor 20 is abnormal (step S51).

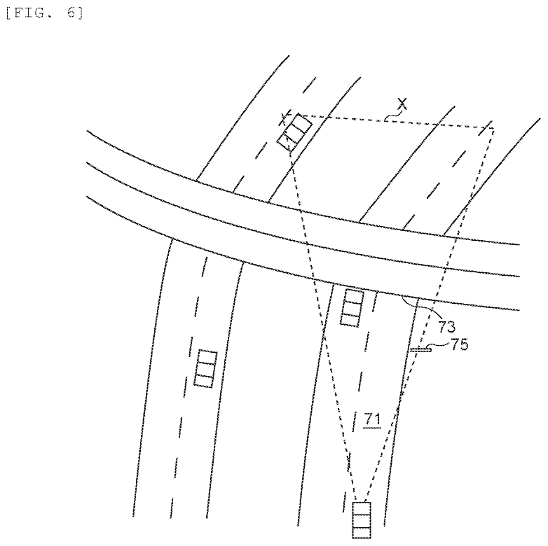

As an example, FIG. 5 illustrates a field of view from the vehicle at certain time. In FIG. 5, a lane 71, a land bridge 73, and a traffic sign 75 are included in the field of view. FIG. 6 illustrates the map data 70 that corresponds to this field of view. On the map data 70, an area X that can be detected by the radar sensor 20 is indicated.

In the case where the radar sensor 20 is not abnormal and the vehicle reaches a position where the radar sensor 20 possibly detects the traffic sign 75 during travel on the lane 71, the radar sensor 20 obtains the detection data that corresponds to the traffic sign 75. On the other hand, in the case where the radar sensor 20 is abnormal and the vehicle reaches the position where the radar sensor 20 possibly detects the traffic sign 75 during the travel on the lane 71, the radar sensor 20 does not obtains the detection data that corresponds to the traffic sign 75, or the error between the detection point and the actual position of the traffic sign is increased. Thus, the control section 51 can determine the abnormality of the radar sensor 20.

The control section 51 may compare the detection data that is obtained by the radar sensor 20 with detection data obtained by another detector mounted to the vehicle in addition to the map data 70, so as to improve reliability of a diagnosis result. Examples of such other detector are an imaging sensor, a Lidar unit, and an ultrasonic sensor. For example, as a result of the comparison of the detection data obtained by the radar sensor 20 with the map data 70 and the comparison thereof with the detection data obtained by the other detector, the control section 51 determines that all the detection data obtained by the radar sensor 20 is abnormal. In such a case, the control section 51 may confirm such a diagnosis result that the radar sensor 20 is abnormal.

As it has been described so far, the abnormality diagnosis system 50 according to this embodiment compares the map data 70, which contains the three-dimensional data on the objects existing on/above the ground, with the detection data obtained by the radar sensor 20, so as to diagnose the presence or the absence of the abnormality of the radar sensor 20. Therefore, by determining whether the radar sensor 20 obtains the detection data on the actually-existing object, it is possible to improve the reliability of the abnormality diagnosis result by the radar sensor 20.

In addition, the map data 70, which is compared with the detection data obtained by the radar sensor 20, is updated by using the data transmitted from the map data generator 1. Therefore, the highly-reliable map data 70 is used, and the reliability of the diagnosis result can be improved.

The preferred embodiment of the present invention has been described in detail so far with reference to the accompanying drawings. However, the present invention is not limited to such an embodiment. It is obvious that a person who has basic knowledge in the technical field to which the present invention pertains could have easily arrived at various modification examples and application examples that fall within the scope of the technical idea described in the claims. It is understood that those naturally fall within the technical scope of the present invention.

For example, in the above embodiment, the description has been made on the example in which the radar sensor 20 is used as the detector to be the diagnosis target. However, the detector is not limited to the radar sensor 20. The detector as the diagnosis target may be any of various sensors, such as the imaging sensor, the Lidar unit, and the ultrasonic sensor, detecting the surrounding environment of the vehicle.

In the above embodiment, the description has been made on the example in which the GPS receiver 59 is provided as the positioning device. However, the present invention is not limited to such an example. The positioning device is not limited to the GPS receiver 59 as long as the positioning device is a device capable of positioning the vehicle on the earth. For example, the positioning device may be a device that positions a current location of the vehicle on the basis of the surrounding environment detected by an on-board sensor such as the radar sensor 20 while referring to the data on the surrounding environment accumulated in the map data generator.

### REFERENCE SIGNS LIST

1: Map data generator
20: Radar sensor
50: Abnormality diagnosis system
51: Control section
55: Storage device
59: GPS receiver
61: Network communication module
70: Map data

1. An abnormality diagnosis system (50) that diagnoses abnormality of a detector (20) detecting surrounding information on a vehicle, the abnormality diagnosis system comprising:
a positioning device (59);
a storage device (55) that stores map data (70) containing data on an object existing on/above ground; and
a control section (51) that diagnoses presence or absence of the abnormality of the detector (20) by comparing the map data (70) and detection data obtained by the detector (20).

2. The abnormality diagnosis system according to claim 1, further comprising a map data generator (1) configured to be located on an outside of the vehicles and wherein
the map data (70) is updated by using data that is provided from the map data generator (1).

3. The abnormality diagnosis system according to claim 1, wherein
the data on the object existing on/above the ground contains three-dimensional data.

4. The abnormality diagnosis system according to claim 1, wherein
the control section (51) diagnoses the presence or the absence of the abnormality of the detector (20) on the basis of an error between data on a specified object contained in the map data (70) and the detection data obtained by the detector (20).

5. The abnormality diagnosis system according to claim 1, wherein
the control section (51) compares the detection data obtained by the detector (20) with detection data obtained by another detector in addition to the map data (70), so as to diagnose the presence or the absence of the abnormality of the detector (20).

6. The abnormality diagnosis system according to claim 1, wherein
the positioning device (59) includes a Global Positioning System receiver.
